(19) United States
(12) Patent Application Publication
(10) Pub. No.: US 2005/0187852 A1
(43) Pub. Date: Aug. 25, 2005

(54) Method and system for account reconciliation in a wealth management system

(75) Inventor: Aimeelene G. Hwang, San Ramon, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Finaplex, Inc.

(21) Appl. No.: 11/060,203

(22) Filed: Feb. 17, 2005

Related U.S. Application Data
(60) Provisional application No. 60/547,151, filed on Feb. 24, 2004.

(51) Int. Cl. G06F 17/60

(52) U.S. Cl. 705/36

(57) ABSTRACT

A method and system for account reconciliation in a wealth management system are disclosed. In one embodiment, a computer-implemented method comprises creating a financial portfolio account having a plurality of data elements. Financial data is received from a plurality of systems of record. Each system of record of the plurality of systems of record correspond to one or more data elements of the plurality of data elements. The financial portfolio account is reconciled with the financial data.

The present application claims the benefit of and priority to U.S. Provisional Patent Application No. 60/547,151 entitled “Asset Management System” and filed on Feb. 24, 2004, and is hereby, incorporated by reference.

### FIELD OF THE INVENTION

The field of the invention relates generally to computer systems and more particularly relates to a method and system for account reconciliation in a wealth management system.

### BACKGROUND OF THE INVENTION

Wealth management companies generally follow a cyclical wealth management process to successfully acquire new customers and build loyal relationships with them. What makes some firms more successful than others, however, is how well they implement that process. Financial institutions strive to streamline operations, improve client loyalty, generate added revenue by rapidly developing and deploying new products and services to their customers, and achieve a real competitive advantage.

However, present wealth management solutions do not adequately address real business problems in the retail financial services industry: a lack of consolidated data, inefficient back- and mid-office operations and high client turnover.

One of the biggest challenges facing financial institutions today is a lack of data consolidation, generally caused by an incompatible mix of technology. Disparate applications perpetuate the “swivel chair” environment of reading data from one screen to key into another, resulting in errors and inconsistencies that take a significant toll on administrative efficiency and customer satisfaction.

Furthermore, wealth management companies fail in organizing the data stored in their systems to allow access in an intuitive manner. Understanding how pieces of data are interrelated is difficult to accomplish with present systems. These inadequacies are in part due to the development of the early systems that centered on an account holder's viewpoint. However, wealth is often managed, viewed, and represented by many different people and institutions. Present systems fail to provide a solution to the real pains felt in the financial industry.

### SUMMARY

A method and system for account reconciliation in a wealth management system are disclosed. In one embodiment, a computer-implemented method comprises creating a financial portfolio account having a plurality of data elements. Financial data is received from a plurality of systems of record. Each system of record of the plurality of systems of record correspond to one or more data elements of the plurality of data elements. The financial portfolio account is reconciled with the financial data.

The above and other preferred features, including various novel details of implementation and combination of elements, will now be more particularly described with reference to the accompanying drawings and pointed out in the claims. It will be understood that the particular methods described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment of the present invention and together with the general description given above and the detailed description of the preferred embodiment given below serve to explain and teach the principles of the present invention.

FIG. 1 illustrates a block diagram of an exemplary client-server system for providing the present method for social and business networking, according to one embodiment of the present invention;

FIG. 2 illustrates an exemplary computer architecture, according to one embodiment of the invention;

FIGS. 3A and 3B illustrate a block diagram of an exemplary financial application architecture, according to one embodiment of the present invention;

FIG. 4 illustrates a block diagram of an exemplary reconciliation component, according to one embodiment of the present invention;

FIG. 5 illustrates a flow diagram of an exemplary reconciliation process, according to one embodiment of the present invention;

FIG. 6 illustrates a flow diagram of an exemplary discrepancy identification process 600, according to one embodiment of the present invention;

FIG. 7 illustrates a flow diagram for an analysis workflow, according to one embodiment of the present invention; and

FIG. 8 illustrates a flow diagram of an exemplary adjustment workflow, according to one embodiment of the present invention.

### DETAILED DESCRIPTION

A method and system for account reconciliation in a wealth management system are disclosed. In one embodiment, a computer-implemented method comprises creating a financial portfolio account having a plurality of data elements. Financial data is received from a plurality of systems of record. Each system of record of the plurality of systems of record correspond to one or more data elements of the plurality of data elements. The financial portfolio account is reconciled with the financial data.

The following terms will be used throughout the description:
holdings=listing of all positions/lots per security held in an account or group of accounts;
lot=the block or quantity of an asset traded as a single trade;
position=aggregated or “rolled-up” lots;
IA=institutional administrator;
portfolio=set of accounts which belong to a specific customer;
account=single set of holdings held at an institution for a specific customer;
cost basis=amount used to signify the original cost of a tax lot held within an account;
discrepancy=when two values are compared and there is a difference in the values;
statement close date=the date that is set for accounts to determine the earliest date changes to the account's transactions or holdings can be made;
reconciliation close date=the date that indicates the last date the account has been reconciled;
reconciliation flag=the indicator that is set for accounts to determine if the account has been reconciled for the current date; and
reconciliation specialists=the users who will be utilizing this component, these can be either internal or external institutional administration type of users.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

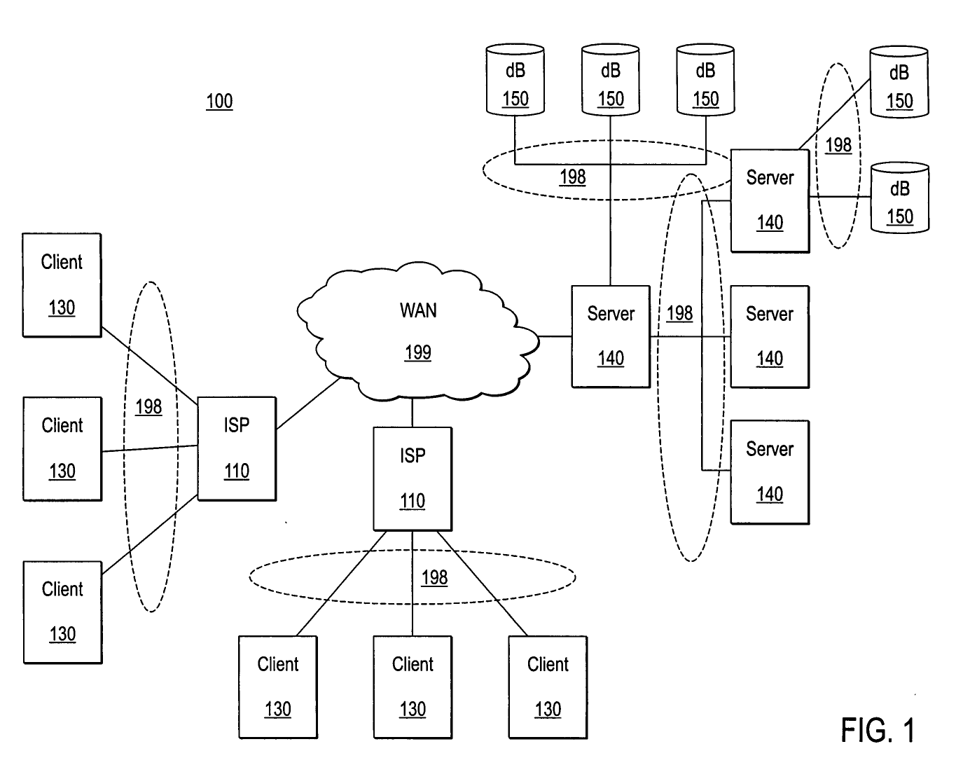

Turning to the figures, the presently preferred apparatus and methods of the present teachings will now be described. FIG. 1 illustrates a block diagram of an exemplary client-server system 100 for providing the present method for social and business networking, according to one embodiment of the present invention. All elements of the client-server system 100 are interconnected via a network. The network connecting all elements of client-server system 100 may be any wide area network (WAN) 199, or local area network (LAN) 198, or combination of LAN and WAN, generally referred to as the Internet.

In general, the network architecture described herein may be implemented as a standard telephone connection provided through an Internet service provider 110 to enable data communication on the Internet over a conventional telephone network. This use of the Internet as a distribution network is well known to those of ordinary skill in the art. In an alternate embodiment through the use of cable modem technology, communication may be performed over a conventional cable network in lieu of, or in addition to, communication over the telephone network via an ISP 110. In another alternate embodiment, through Integrated Services Digital Network (ISDN) technology, the network is accessed using an ISDN modem, also via an ISP 110. Both clients 130 and servers 140 can access the Internet through the architectures described above.

The clients 130 and servers 140 can be any type of computing device including a personal computer. The workstations (clients 130 and servers 140) may be a combination of proxy servers, web servers, application servers, and database servers. Web servers are responsible for handling the incoming client requests, decrypting the secure connection, bridging to the application server for dynamic content, and serving static content. Web servers tend to have relatively little load since the majority of the application is dynamic in nature. The management and gateway servers take care of periodic batch processes, integration tasks, and other monitoring functions. Performing these functions on dedicated machines but often provides an enhanced level of security by better isolating the application servers and providing finer grained control of system resources. The application servers run the business components and related functionality. Typically, the J2EE web application executes on the application servers along with the EJB and middleware components for enhanced performance, though these functions can be separated if desired.

Workstations 10 may be any of a SUN Ultra 60, Ultra 80, Ultra 450, Blade 1000, HPJ6000, IBM RS/6000 F80, Dell Workstation 530, IBM Intellistation ZPro 6866, Intel Server, IBM I-Series Server, IBM Z-Series Server, or similar computing device. Various operating systems are supported on workstations 10, such as Sun Solaris, AIX, Win 2000, zOS, Linux, and MacOS. Workstations 10 also run various software components such as iPlanet, Apache, WebLogic 7, and WebSphere 5.x.

Typically, databases 150 will comprise a SQL (structured query language) relational database management system (RDBMS) database, such as one of the SQL RDBMS database products provided by Oracle (Oracle 8i, 9i), Microsoft (SQL Server 7), Sybase, IBM (DB2) and Informix. Optionally, the databases 150 may comprise a non-SQL-based server product, such as the Microsoft's Access database or Paradox. The database servers run queries against the data models and execute data manipulation stored procedures. The wealth management data can be quite large, as major institutions will keep 18 months or more of historical data online across a wide customer base. According to one embodiment, RAID disk arrays are attached to the database server locally to provide local storage and facilitate high availability. The database machines, however, tend to use either fiber channel loops or a SAN to make a large, redundant storage array available to the database servers. This provides high performance across all the machines and minimizes the overhead and tasks required for system redundancy. Financial application architecture 300 supports both standard UNIX and Windows environments and selected database and management components can run on OS/390 as well.

Note that any or all of the components of the system illustrated in FIG. 1 and associated hardware may be used in various embodiments of the present invention; however, it will be appreciated by those of ordinary skill in the art that any configuration of the system may be used for various purposes according to the particular implementation.

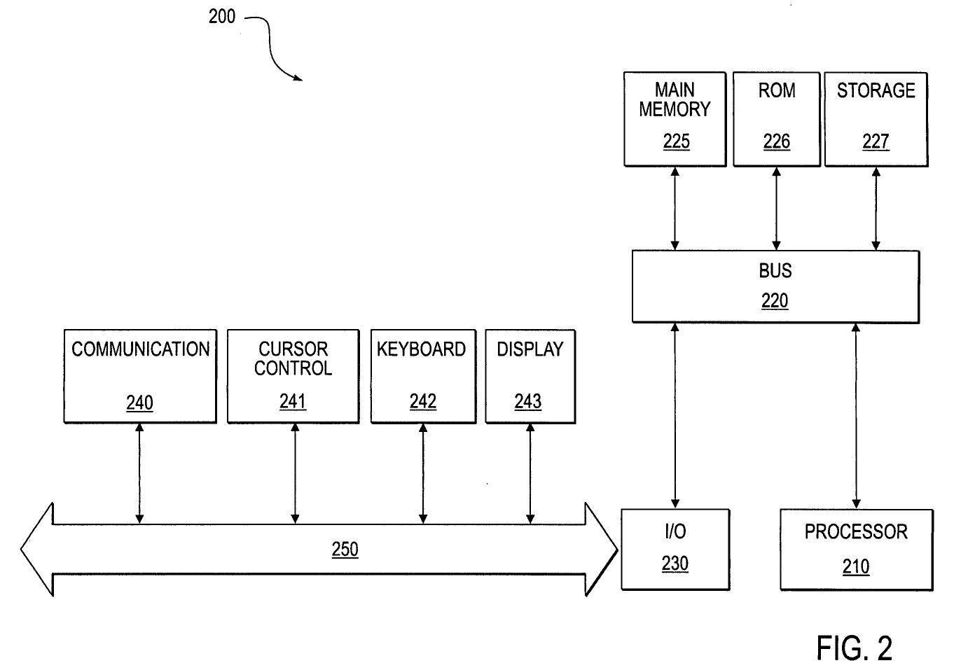

FIG. 2 illustrates an exemplary computer architecture, according to one embodiment of the invention. Computer architecture 200 can be used to implement both clients 130 and servers 140 of FIG. 1. One embodiment of architecture 200 comprises a system bus 220 for communicating information, and a processor 210 coupled to bus 220 for processing information. Architecture 200 further comprises a random access memory (RAM) or other dynamic storage device 225 (referred to herein as main memory), coupled to bus 220 for storing information and instructions to be executed by processor 210. Main memory 225 also may be used for storing temporary variables or other intermediate information during execution of instructions by processor 210. Architecture 200 also may include a read only memory (ROM) and/or other static storage device 226 coupled to bus 220 for storing static information and instructions used by processor 210.

A data storage device 227 such as a magnetic disk or optical disc and its corresponding drive may also be coupled to computer system 200 for storing information and instructions. Architecture 200 can also be coupled to a second I/O bus 250 via an I/O interface 230. A plurality of I/O devices may be coupled to I/O bus 250, including a display device 243, an input device (e.g., an alphanumeric input device 242 and/or a cursor control device 241). For example, web pages and business related information may be presented to the user on the display device 243.

The communication device 240 is for accessing other computers (servers or clients) via a network. The communication device 240 may comprise a modem, a network interface card, a wireless network interface or other well known interface device, such as those used for coupling to Ethernet, token ring, or other types of networks.

Having described the hardware architecture of clients 130 and servers 140, a description follows of the operating system and software used to perform the features described herein. Internet browsing is implemented through client computers 130, HTTP server computers 140 and HTTP browsers. Servers 140 play the role of archives for providing data, and client 130 play the role of customers or consumers of the data. Typically many clients connect to a single server. Special server and client software may also be employed, depending on the specific application design architecture.

An Internet browser, such as Microsoft's Internet Explorer or Netscape's Communicator, is a piece of software which resides on a client computer. When executed by a user, the browser opens a Uniform Resource Locator (URL), which resides on a server 140. Typically, the URL is a Hyper-Text Markup Language (HTML) page, which is sent back from the server 140 to the client 130. The HTML page has instructions for the browser, which instruct the browser how to render the page for display. The page typically has additional URLs embedded in it, and when the user clicks on one of them, the server 140 then sends a new HTML page for the browser to render.

HTML pages can contain both text and graphics, along with layout instructions. Images appearing on an HTML page also reside on the server 140, and are sent to the client 130 when the browser finds a link to an image on the HTML page it is rendering, and then instructs the server 140 to send image data. The beauty of this is that the images reside on remote computers, and do not have to be stored locally on the client 130. Otherwise, the client would have to store every image it views, either on its hard disk or on a storage medium such as CD-ROM, regularly replacing these images with updates. Both images and data can be stored in databases 150 that are attached to servers 140 directly or through network(s) 198.

The actual data communication between the server 140 and the client 130 is governed by Internet protocols, such as Hyper-Text Transfer Protocol (HTTP). These protocols define packets of data to be sent, and can include handshakes for negotiating data-link control, to verify if the data arrived intact. Specifically, the HTTP protocol sits as a layer on top of TCP/IP protocol.

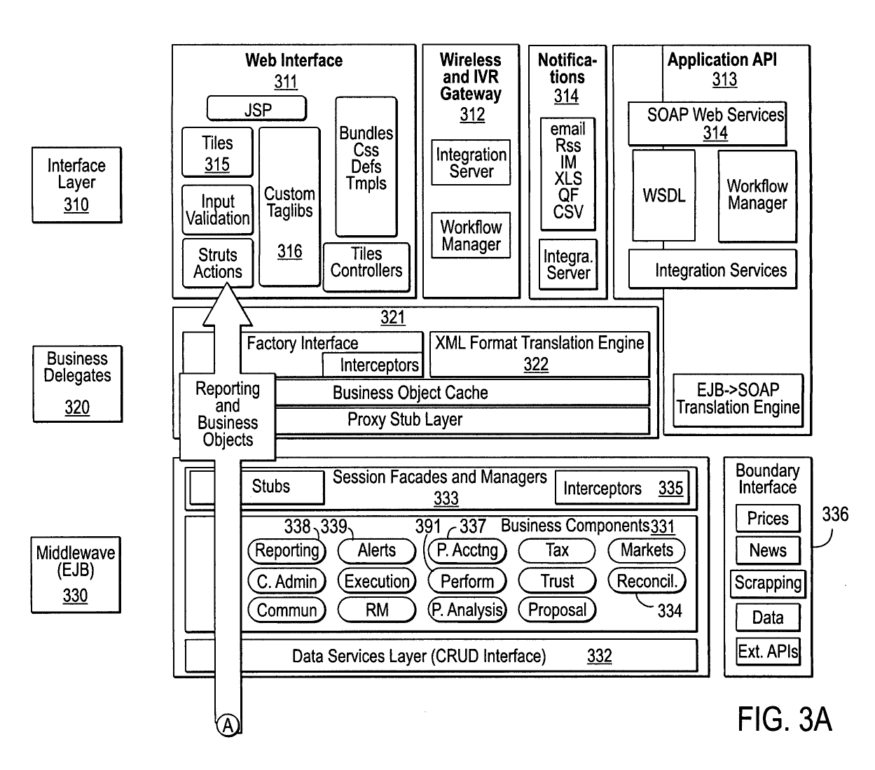

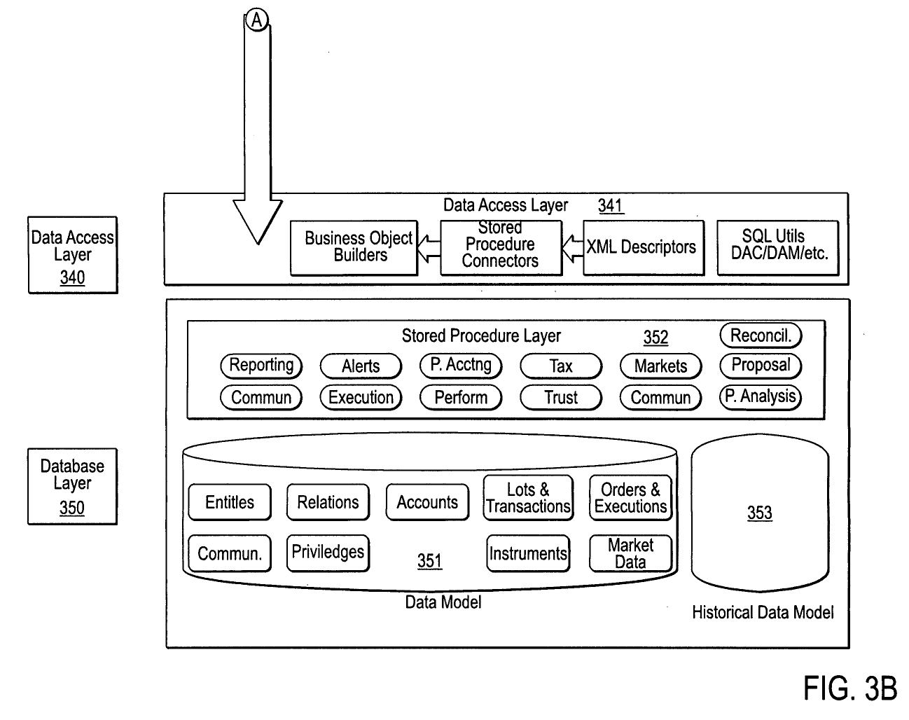

FIGS. 3A and 3B illustrates a block diagram of an exemplary financial application architecture, according to one embodiment of the present invention. Financial application architecture 300 is a comprehensive application suite that services the needs of all key participants in the wealth management cycle. In one embodiment, financial application architecture 300 takes advantage of J2EE standards using common industry leader and open source web, application, and database servers. These standards are laid out in a tiered application that provides high performance, flexible deployment, multitudinous interfaces, and future scalability. Redundant server stacks can be configured in a number of arrangements to utilize both commodity and high-end hardware to achieve high availability and expand capacity as deployment scale increases.

The software architecture of financial application architecture 300 provides a flexible core of functionality that lets each of the actors in the wealth management cycle to perform their functions through a holistic suite of technology. Financial application architecture 300 is flexible, fast, intuitive, and highly customizable for each user. At the same time, financial application architecture 300 integrates all the user's data together into a single coherent structure and allow interactions between users to be coordinated in a consistent fashion. Financial application architecture 300 is also customizable and extensible from the start, allowing professional services, clients, or third parties to easily integrate it with existing systems or build new front ends on top of proprietary components.

The core of financial application architecture 300 is the data model 351, which is the first of its kind in integrating all types of wealth data into a single coherent structure. The data model 351 is a normalized relational database (such as database 150) with selected performance enhancements that blend well-linked, easy to use data, with fast application response and easy data maintenance. Data model 351 is further extended by a companion historical database 353 that integrates with the data model 351 and integrated data manipulation logic, which provides high performance across large reports and data sets.

Financial application architecture 300 is delivered primarily as a web application. A web interface 311 provides the most pervasive interface which is readily accessible and familiar to both client institutions (users) and their customers. Web applications are also simple to interact with and make it easy to navigate among large quantities of information. Financial application architecture 300 additionally supports the web interface with wireless 312, voice 312, notification 314, and application 313 interfaces discussed below.

J2EE is an enterprise Java platform used for constructing web interface 311 that makes it easy to build flexible, yet powerful web applications and integrate them with databases. J2EE also provides an attractive technology platform on which to develop and deploy the business components of financial application architecture 300. J2EE was additionally selected due to the strong vendor and open source support for the technology suite and the ability to use existing technology for many of our needs.

To enhance the web interface 311, financial application architecture 300 provides an application API 313 that is provided natively through the web. API 313 is implemented as a SOAP web service 314, which combines well structured data, simple cross language/platform bindings, and well formed error handling. API 313 also provides support for wireless 312, IVR 312, and syndication. Each layer of financial application architecture 300 will be described below.

Database layer 350 includes data model 351. Data model 351 is responsible for organizing the user (financial organization) and customer (financial organization's customer) wealth information into a single consistent schema. This schema is a normalized modeling of the full range of data required for wealth management, with performance tweaks that enable high performance against large or complex queries. Financial application architecture 300 data model 351 is a comprehensive structure with over 300 tables and accommodates a wide range of complicated data including detailed accounting, fine grained permissions, complex trust and estate relationships, and historical snapshots and audit histories. Historical data model 353 is optimized for time series data while still integrating with data model 351. Data model 351 is designed to be compatible with a variety of database vendor's products, although according to one embodiment Oracle is used.

Database layer 350 also includes stored procedures layer 352. The data manipulation tasks of the business components 331 are implemented as stored procedures 352 in the database layer 350. This allows for very fast response times across large data sets and powerful queries able to winnow particular details without advanced planning.

Data access layer 340 provides a powerful binding between the relational data and stored procedure results 352 and the object oriented business components 331 used to build the web interface 311. The data access layer 340 automatically generates the proper bindings to create the appropriate business objects for a particular query or action.

Middleware layer 330 includes a data services layer 332. Financial application architecture 300 abstracts a data services layer 332 underlying its business components 331 to allow for simple integration with a variety of systems. The data services layer 332 has a granular interface for working with basic data elements such as entities, accounts, lots, transactions, and instruments. The data services layer 332 is used internally to ensure that all data interface is made in a consistent manner and has well formed validation, concurrency checking and also provides a low level external interface that can be used for high performance data integration and system of record reconciliation. Boundary interface 336 communicates with a variety of Systems of Record (SORs).

Middleware layer 330 also includes business components 331. Business components 331 are reusable components that provide a repertoire of capabilities that can be drawn upon by web 311 and other interfaces. Business components 331 cover a range of functions from reporting, and relationship management to entitlements. Reconciliation component 334 allows for identifying and repairing discrepancies in account data. For example, when transactions relating to a position imply a different position quantity than supplied in the SOR's position, the transactions need to be amended.

Middleware layer 330 also includes session facade and managers 333. The session facade and managers 333 simplify interaction with business components 331. The facades provide a single point of access for complex behaviors within the business components 331 without requiring callers of this interface to worry about serialization, transactions, ancillary data, or other complexities. Facades 333 also encapsulate much of the workflow of the wealth management cycle and provide the ability to use interceptors 335 to extend existing functionality without having to change the existing components.

The business delegate layer 320 is a bridge between the interface layer 310 and the middleware layer 330. The function of the business delegates 321 is to further simplify building highly customized interfaces while also improving performance through caching. The business delegate layer 320 also has a format translation engine 322 that can marshal data into xml formats for many different types of system integration.

The interface layer 310 includes a web user interface 311 that provides a series of portals oriented around the workflow of the actors in the wealth management cycle. Struts and tiles 315 are used to create a MVC (model-view-controller) framework that make reuse easy and provide high performance and customizability at the same time. Custom tags 316 are used for simpler data driven elements. Tile templates, definitions, and css/png graphical presentation allow for highly flexible client branding. All of these elements are pulled together into a usability-oriented interface 311 that emphasizes the workflow and navigation patterns of the end user and hides the robust and complex components that are drawn upon to create these screens.

Web interface 311 is a very effective mechanism for working with customers currently engaged in a wealth management function, but has weaknesses in serving end users not currently at their computer or applications needing to integrate with financial application architecture 300. In addition to the primary web interface 311, a range of other mechanisms of interacting with the application are provided. Offline users can employ wireless (WML/cHTML) 312, voice, and notification 314 (email, instant messaging, rss, etc.) systems to stay abreast of key events or information accessible via financial application architecture 300. A SOAP web services API 314 makes application integration easy, cross-platform, yet robust with well-structured data, interfaces, and error handling. Workflow, integration, and translation servers encapsulate common behaviors across these systems and tailor the customer experience appropriately to the medium being used.

Other software used by Financial application architecture 300 includes open source Java technology such as Apache's Struts, Taglibs, Tiles, Axis, and Cocoon; JDOM, JXL, JAX, Log4J, and Xerces Java libraries; perl for scripting; Junit, Cactus, and Grinder testing frameworks; etc. Technowledge or Yodlee commercial packages can be used for web based data integration and Kava for Java based charting. Additional software is used for monitoring, networking, and management.

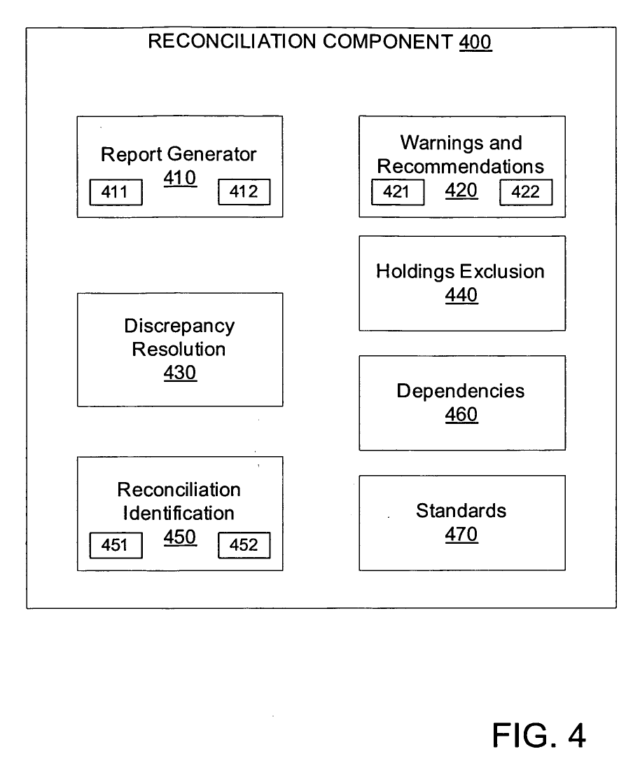

FIG. 4 illustrates a block diagram of an exemplary reconciliation component, according to one embodiment of the present invention. Reconciliation component 400 ensures the integrity of the data provided and calculated through portfolio accounting component 337. The effect of using the reconciliation component 400 provides the same level of integrity to the information provided in the reporting 338, alerts 339 and performance 391 components.

The data stored and calculated within financial application architecture 300 can be provided by multiple sources of data. In order for this data to be verified, there is another system that this data needs to be compared to. These external systems are those that provide statement data that the customer views as an audited summary of account information pertaining to its holdings, transactions and performance. Reconciliation component 400 allows the client to identify, analyze and adjust their account information or other data stored in financial application architecture 300, to ensure the integrity of their data provided to their end-users (customers).

Institutions often have one or more systems that maintain similar data sets. Those data sets should be the same in all systems and need to be verified through a reconciliation process. It is first necessary to determine which system is deemed the ‘Books and Records’ for each data set, or the System of Record (SOR). Users of financial application architecture 300 can choose to reconcile other systems to the data stored in the data model 351 or vice versa. Therefore, the SOR can be financial application architecture 300 or an outside system could be deemed the SOR. In either case, both systems need the ability to provide data that can be matched for comparison to other data elements. For example, holdings reconciliation requires an account and security identifier in both systems to be identical, this way the other attributes of the holdings position in both systems can be compared against each other.

Returning to FIG. 4, reconciliation component 400 is capable of identifying discrepancies. The reports generation module 410 automatically generates reports to help a reconciliation specialist identify accounts or data in the database layer 350 that is either out of synch with the SOR or missing. These reports should be able to be run at any point in time so that the reconciliation specialist can release data that is deemed reconciled. There will be a need for the reconciliation specialist to run the same report several times throughout the day to verify fixes made to data. Once the accounts/data has been recognized as reconciled through these reports the data should be able to be made immediately available to other users.

Reports generation module 410 includes filters component 411 to filter the entries of discrepancies on a report. Filters component allows for reports to present information tailored to the specifications of a reconciliation specialist. Account filters of filters component 411 allow the selection of an account(s), group of accounts, portfolio(s), or household groups. Filters component 411 allows for reports to default to the user's preference or previous pages selected filter values. An “as-of-date” filter defaults to the previous business date (date of the SOR data to compare against). Additional filters of filters component 411 provide the ability to choose quantity and/or market value and/or cost basis to reconcile holdings.

A display filter that is part of filters component 411 allows for the filtering of reconciled accounts—those are reconciled accounts are accounts where there is no discrepancy for the chosen values to be compared in the reporting options. The reconciled accounts filter allows for the report to list the name and number of the reconciled accounts. The display filter also allows for the display of tolerance reconciled accounts—those are accounts that fall within a tolerance level for a user-chosen values to be compared in the reporting options. The tolerance reconciled accounts filter allows for the report to list the name and number of the reconciled accounts.

The display filter also allows for the display of unreconciled accounts—those are accounts where there is a discrepancy or falls outside of the tolerance level for the chosen values to be compared in the reporting options. The unreconciled accounts filter allows for the report to list the name and number of the reconciled accounts and its corresponding holdings where the discrepancy lies. The display filter also provides the option to display all accounts—those are all the accounts chosen in the account filter, whether they are reconciled or unreconciled.

Reports generation module 410 includes reporting options component 412. Options component 412 allows for the creation of groups. If a user decides to create groups, at least two groups are created:
1) Reconciled Accounts =>“Reconciled”+“Qty and/or MA and or Cost”+dd mmm yyyy Example: Reconciled Qty 30 Jun. 2003
2) Unreconciled Accounts =>“Unreconciled”+“Qty and/or Mvl and or Cost”+dd mmm yyyy Example: Unreconciled Qty 30 Jun. 2003

By default these account groups are only available to the user as user defined groups but a reconciliation specialists can allow other users as per their designation the rights to see/use these account groups. A “within tolerance” group can also be created. The groups are available to all administrators (reconciliation specialists) who are given access to the reconciliation pages/component 400. They see the most updated groups from the latest reconciliation report displayed in their account group drop down lists.

Reporting options component 412 also provides tolerance settings. This option provides the ability to set up tolerance levels for each value to reconcile. A default tolerance level is set at zero, meaning there is a zero tolerance level and the SOR and application architecture 300 data should match exactly. Depending on the type of data that is being reconciled the tolerance level can be numerical or text. Users can set the tolerance level to be a specific value or %-of-difference value or leave it blank. The tolerance level is also used to trigger an event, signifying that there is a discrepancy that has fallen within the tolerance setting and; therefore, signifying the account is reconciled for this type of data. If the difference falls outside of the tolerance setting then the account is considered unreconciled for this type of data. For example, if a text value is missing but is found in the SOR data set then a notification states that a non matching value adjusts the data value in data model 351 to be replaced by the SOR data value. Tolerance settings can be created or altered at run time when the customer is creating the report. This could also be set at the institutional level per report created.

Reporting options component 412 also provides output options at run time. For example, options exist to display the report on the screen, publish the report on the site for others to access, or save the report to a specific location. The customer can choose to save or publish the report before or after the report has been run. When publishing the report on the site, the customer can designate user(s) with the entitlement to view it and the name of report. When saving the report to a specific location the customer can designate a report name, format and location of the file.

Reporting options component 412 also provides auto report generation options. A report can automatically be run at a specific date, day and time. Customers can choose to run a report everyday at specific time or be triggered by an event. The report can be automatically published to be retrieved by customers with the proper entitlement. When the report is automatically published, the customer can set up in advance: the name of the report, the format to save as, whom to publish the report to, which customers to send or forward the report to, pre-set filter options, the file type and download location.

Reconciliation component 400 includes a warnings and recommendations (W&R) module 420. W&R module 420 includes an alerts component 421. In some cases, there may be the need for certain users to be made aware of the account's reconciliation discrepancies. There could be one or more customers who should be notified once an account's holdings become out of balance so that the customer can act on this account to either fix the discrepancy or to simply be aware that this account's holdings are out of balance. Reconciliation specialists have the ability to set up alerts based on a reconciliation discrepancy and to designate those customers who should be notified.

A group of users is made aware of a set of accounts that become unreconciled for any given day due to a particular nature of the discrepancy. Alerts component 421 creates alerts that are triggered based on the type of the reconciliation discrepancy found. Alerts can be created for any type of reconciliation discrepancy, such as position, taxlot, transaction, security (instrument) and/or account discrepancies (all described below). For example, a discrepancy alert will be generated if a unit is responsible for the posting of income transactions in the portfolio accounting component 337 and the set of accounts which they have posted income for become unreconciled due to the posting of these income transactions. Another instance in which a discrepancy alert is automatically generated is when income cash amounts do not match the SOR.

For position discrepancies, reconciliation specialists choose to reconcile holdings on a position basis. Position level data stored in financial application architecture 300 is reconciled to SOR data if this is the only type of holdings data made available by the SOR. This type of reconciliation is done for several data elements per position: quantity, market value and cost basis, at the reconciliation specialists' discretion. The data matching criteria to be used for comparing positions will primarily use the account number and security identifier values stored in both systems. The user does this comparison at any given date and time so as to allow users to reconcile on a trade or settlement date basis either for current or previous dates at any point in time. The data provided by the SOR for any previous date reconciliation is used for only that date unless the SOR has dictated that the data is ‘reconciled’ data. There are a number of corrections the SOR could create that will cause a previous date's positions sent as no longer accurate. Some systems provide a ‘reconciled’ data file and therefore, this ‘reconciled’ data file is processed and a reconciliation is performed based on ‘corrected’ position data within financial application architecture 300 to compare to this ‘reconciled’ data.

For tax lot discrepancies, users reconcile holdings on a tax lot basis. This functionality is available when the data provided by the SOR can release data reflecting tax lot information, unique tax lot identifiers, cost basis and purchase dates. Typically this type of reconciliation is not done daily but monthly/quarterly/semi-annually/annually due the amount of time and effort necessary to facilitate this reconciliation process. This reconciliation is typically performed in conjunction with the timing of statement generation from the SOR. The data matching criteria is dependent on the information provided by the SOR/source systems since most systems recycle their tax lot identifiers, often times there is no unique way to identify a tax lot from one system to another.

For account information discrepancies, accounts held within financial application architecture 300 contain data that is used to determine calculations and therefore the accuracy of this data is necessary for users to view their individual account information accurately. Reports are available to the user to identify where data is missing and/or inconsistent with the SOR. The entitled users will then need the ability to change the account information and recalculate data for the account if the change affects data calculations.

For transaction discrepancies, reconciliation is used when transactions are posted within the portfolio accounting component 337 and compared to those posted in the SOR. Typically, the source system for the transactions is separate from the SOR. The source of the transactions posted in financial application architecture 300 can be either manual input or automatic input, originating in financial application architecture 300. There could be an alternate interface to receive all or specific types of transactions from other systems, like Trade Order Entry systems. Depending on how data is fed into the portfolio accounting component 337 this type of reconciliation may or may not be needed. If the transaction data is being fed into the portfolio accounting component 337 from the SOR then this type of reconciliation is not necessary.

The transaction reconciliation is flexible enough to allow users to designate specific transactions that need to be reconciled or designate those transactions that do not require to be reconciled against another system. The characteristics to match on as well as the items to reconcile are defined by the user at either the institutional, account or transaction level. The characteristics of each transaction has the capability to be matched with the SOR as well as tolerance levels determined by the reconciliation specialists.

For securities information reconciliation, reconciliation component 400 determines if there is any missing security information for any given date. The data elements necessary to perform calculations within the components: performance 391, portfolio accounting 337, alerts 339 and reporting 338. A price is available for every security with any activity and or holdings within any account stored in financial application architecture 300. Reconciliation specialists are notified when a price is not received for a security that is held in any account on any given day or has activity on a date for any given account. Prices are used throughout the application to determine market values that are used to determine data used in calculations in the performance 391, portfolio accounting 337, alerts 339 and reporting 338 components. A report is generated that compares prices stored for EOD to the price data received from the SOR as of EOD. This type of report is used to identify any discrepancies in prices per security, and could be used in place of reconciliation of market values across accounts for all holdings since market values are based upon the prices received from the SOR.

Reconciliation component 400 determines if the dividend rates and interest rates for all securities held at any point in time in any account are available. These rates allow our components to determine the income earned within and account and to be utilized to post income records to any accounts stored in data model 351. Performance calculations and reporting displays are dependent on this data being available for all securities held in any account at any given time. Often users will request performance information based on the classification of their securities from a historical perspective and this data should be made available for all securities for historical performance to be made available. When reclassification of securities is done, the reconciliation specialists is notified of these changes as well as administrative user types, since this would potentially require the performance numbers to be reevaluated.

Warnings and recommendations module 420 also includes a reporting component 422. Reporting component 422 is used as a reconciliation tool to help aid users in resolving discrepancies by recommending solutions. Various warnings reports are created to identify common issues and recognize potential causes of discrepancies, for example missing transactions that appear on the SOR data but do not exist within the account transaction data within data model 351.

A complete understanding of how each system of record treats and records each of the following transactions is evaluated before implementing data into the portfolio accounting component 337. (e.g. either the SOR does or does not send accruals.) Many scenarios can cause discrepancies within the reconciliation process. The following list provides possible discrepancy causing events, although other discrepancy causing events are also contemplated:
Corporate actions—due to delayed postings, or some accounts on the SOR not yet posting the corporate action due to some restriction on the account;
Cost basis—bad or missing original cost information, changes in the SOR are not passed into financial application architecture 300, and rejections in the boundary interface 336;
Any incorrect posting of closing transactions, like sales posting to the wrong tax lot within the account could cause cost basis discrepancies;
Transactions received via the boundary interface 336 with one or more missing data elements could cause any items to become out of balance, quantity, cost basis, market value;
Often trade date activity received could be altered before settlement date but these updates could be potentially missed in the boundary interface 336 and not update the data model 351 correctly (or not at all);
Adjustments made to the account within the SOR that have not yet been received into data model 351 due to the unique nature of the adjustment—often administrators know how to manipulate the SOR outside of normal processing which could be missed in the boundary interface 336. For example, some systems allow holdings data to be changed without forcing the customers to create a transaction but rather directly change the account data with only an audit trail being generated for the account's activity to record changes.

Reconciliation component 400 includes a discrepancy resolution module 430. Discrepancy resolution module 430 provides functions to manually fix entries; fix entitlements; suppress transactions; update, delete, and add transactions; back-dated transaction handling; reconciliation date updating; and automatically reconcile entries.

In regard to manually fixing entries, the manual entries are automoatically discernible from those that are received from a source system. The reconciliation specialists who are reconciling the data should be able to post transactions to accounts and make adjustments to other data while having these postings monitored through an audit trail.

In regard to the ability to fix entitlements, reconciliation specialists are entitled to make adjustments to the accounts. There may be different levels of specialists that can do certain adjustments while others cannot due to institutional requirements. Some reconciliation specialists can alter account transaction data but are not permitted to alter security information such as pricing data. Often there are separate units of reconciliation specialists that are experts in specific areas of reconciliation as designated by the institution. According to one embodiment, certain reconciliation specialist units are dedicated to the maintenance of account information (characteristics) but separate units are responsible for the processing of corporate actions and the reconciliation of the accounts affected by these events. Discrepancy resolution component 430 allows for particular institutional requirements. For example, the requirement from an institution could be to not allow the corporate action team the ability to alter account information (characteristics) but to allow them to alter account transactions.

In regard to the ability to suppress transactions, a number of adjustments can be set as ‘suppressed’ whereby the customer (or other users) should not see these types of records. These could include any number of transactions ranging from the addition of correcting transactions or change/update records. The customer is concerned about the end resulting transaction records as opposed to the records. The suppressed records' affect on the account's holdings are applied, but record of this transaction may or may not be relevant to all users who view the account's activity. The suppressing of transactions is done at either the ‘type’ or individual transaction level.

In regard to the ability to updating, deleting, and adding transactions, adjustments to accounts are enabled both at a single account level and a group account level. Often times the SOR transactions are posted in a ‘Batch’ to more than one account. A batch can contain a single account as well. If an error is made to even one data element of that single transaction, all accounts are fixed just as the transaction is made, in a single batch. The transaction adjusting functionality posts corrections both to a single account or to a group of accounts. All transactions are made available to be altered by those who are entitled to this functionality; typically these are the reconciliation specialists or administrative type users.

Due to the phased approach of supporting only specific security types and transactions within the portfolio accounting component 337, there is the potential of a transaction posted that is also not supported. This can cause a supported position to become unreconciled. All transactions that occur in an account are made available to the reconciliation specialist to change or reclassify as part of portfolio accounting component 337 (or not part of portfolio accounting component 337). Upon reclassifying the transaction the user should can assign the action to the account's holdings. Therefore, the reconciliation specialist changes transactions that are ‘not supported’ to be ‘supported’ so that they can be calculated as part of a fix for the reconciliation issue.

In regard to the ability to handle back dated transactions, SOR transaction data can contain a back dated transaction. When these transactions occur, reconciliation specialists are alerted of the impact of this ‘back dated’ transaction. The reconciliation specialists can generate functions in the application to generate a previously created report that has been published to user/users or to regenerate historically calculated numbers used by other components the user has implemented. For example, the user may need to trigger the regeneration of performance numbers due to a back dated transaction.

In regard to transactions impacting the reconciliation date, an extension of back dated transactions is year end transactions that are not known until January but are to impact the prior year values. This is typical for mutual find distributions, fee amounts, and several other income/dividend transactions. These transactions update historical calculations for every date from the effective date to the actual date. Prior Year Transactions are created during manual input or from SOR activity.

In regard to the automatic reconciliation of entries, automatic transactions posted to accounts are marked for reporting purposes so that if an automatic fix that is created in the load of the data needs to be removed, the reconciliation specialist can easily identify these records. Additionally, automatic fix entries can be audited by a reconciliation specialist for acceptance into the system 300. These types of entries are performed through a series of utilities, corporate actions utility, batch transaction updates, deletions, and additions. Through a set of rules that the user creates, transactions to commit to the account's transaction data, security information, and account information are automatically generated. These rules can be based on the outcome of the reconciliation reports and the type of discrepancy. These rules could also be based on a series of business rules the institution has decided upon implementing. Institutional users can create or alter certain transactions when received from other systems as well. The rules to generate such transactions should are based on anything from the account's holdings, the type of security, and the actual security itself.

Users can alter data received from the other systems to state that specific data elements will be ignored and instead use data from a separate source for those data fields. For example, pricing information from specific sources could be used for specified securities or security types.

Reconciliation component 400 includes a holdings exclusion module 440. Holdings exclusion module 440 allows a reconciliation specialist to designate accounts to be excluded from the reconciliation process. The reconciliation specialist has the ability to reconcile holdings information for the account and designate specific positions within the account to exclude from reconciliation. For those reconciliation specialists who designate specific positions, taxlots and/or accounts—this is done through a RE (Change Reconciliation Flag) transaction. Based on the data fields for the transaction that are populated the ‘Is_Reconcilable’ flag is set for the account/position/tax lot. Designation of specific positions, taxlots and/or accounts are set by security type level and an individual-security level. For reconciliation specialists to designate specific securities or security types, a utility allows the reconciliation specialist to search for the security or security type and to attach the characteristic to exclude all accounts who are holders of this security or security type.

For example, some corporate actions posted within a set of accounts may not have been completed due to missing information and are posted to all accounts at a later date. Therefore, while there may be one or more accounts with unreconciled positions, these accounts could actually be reconciled to all other holdings and at a later point become part of the reconciliation for the entire set of holdings once the other system(s) posts the corporate action to all accounts. There is also an option to set this for other types of reconciliation, transaction, security, and account information at the security, transaction or account levels.

Reconciliation component 400 includes a reconciliation identifier module 450. Reconciliation specialists need to clearly identify reconciled versus unreconciled data. This identifier(s) could be used to either display to all users a standard disclaimer to state that the data is currently unreconciled or to prevent some users from viewing data that is unreconciled. Therefore, a flag to state if an account/transaction/security is reconciled or not (is reconciled) as well as a reconciliation date (reconciliation_dt) is used.

Reconciliation identifier module 450 includes an automatic update module 451. With automatic update module 451 a reconciliation specialist sets up rules on how the is_reconciled and/or reconciled_dt fields are updated automatically. The following options are available for updating both fields or updating them separately:
Is_Reconciled->
   When a reconciliation report is generated for the current position date:
      Accounts without discrepancies will be updated to set the value to Yes (1)
      Accounts with discrepancies will be updated to set the value to No (0)
   When a reconciliation report is generated for a previous position date
      Accounts without discrepancies will be updated to set the value to Yes (1)
      Accounts with discrepancies will be updated to set the value to No (0)
   When a reconciliation report is generated for the current position date
      Accounts without/with discrepancies will not be updated.
   When a reconciliation report is generated for a previous position date
      Accounts without/with discrepancies will not be updated.
Reconciled_Dt->
   When a reconciliation report is generated for the current position date:
      Accounts without discrepancies will be updated to set the value to current position date.
      Accounts with discrepancies will not have this field updated.
   When a reconciliation report is generated for the current position date
      Accounts without/with discrepancies will not have this field updated.
   When a reconciliation report is generated for a previous position date
      Accounts without/with discrepancies will not have this field updated.
   When a reconciliation report is generated for a previous position date
      Accounts without discrepancies will not have this field updated.
      Accounts with discrepancies and a reconciled dt value later than the as of date of this report, will be updated to the closest reconciliation dt. (need to store a log of all reconciliation_dt values to track the, date of change, old value, new value, and how it was changed—user's name, and report's name)

Reconciliation identifier module 450 includes a manual update module 452. A reconciliation specialist can update the is_reconciled and reconciled_dt fields manually. The reconciliation specialist can choose to update both fields or just one of them. With the is_reconciled utility, the reconciliation specialist can:

Designate which account(s) to update as-

All Accounts
All Accounts where the reconciled_dt is equal to today's position date
All Accounts where the reconciled_dt is not equal to today's position date
Another Account group available to the user
Single account
Unreconciled Group of accounts created by the Holdings Recon report
Reconciled Group of accounts created by the Holdings Recon report
   Set the value for the is_reconciled field-
Yes (1)
No (0)
   Determine when to updatethe is_reconciled field-
Designate date or day (Everyday, Every Monday . . . )
Designate time or time of day (EOD/BOD)
Now

With the reconciled_dt utility, the reconciliation specialist can:

Designate the account(s) to update-

All Accounts
All Accounts where the is_reconciled is equal Yes (1)
All Accounts where the is_reconciled is equal to No (0)
Another Account group available to the user
Single account
   Set the value for the reconciled_dt field-
User defined date—manually entered
Today's position date
   Determine when the field should be updated-
Designate date or day (Everyday, Every Monday . . . )
Designate time or time of day (EOD/BOD)
Now

Reconciliation component 400 includes a dependencies module 460. With the dependencies module 460 the accuracy of the data used for the following dependent components is maintained:
Reporting 338
Portfolio Accounting 337
Performance 391
Tax 331
Alerts 339

The above listed components are dependent on the reconcilement of data that is stored within financial application architecture 300. There are a number of data elements and calculations which these components use and which dependencies component 460 ensures the integrity of. For example, holdings information is used throughout all of these components and one of the basic functions of this component will be to ensure the holdings reported in the data model 351 match the holdings as communicated through the SOR.

Performance calculations are also very dependent on the security and transaction information entered into financial application architecture 300. Since the performance component 391 needs a high level of data integrity to properly calculate cash flows and balances, it is much less forgiving of data errors than transaction or holding reports. Data errors like inaccurate prices, missing exchange rates, and unposted coupons or dividends can cause inaccurate rates of return. Portfolio accounting 337 and performance measurement 391 have an impact on the reconciliation component 334. Any impacts of additions or deletes to transaction codes are reviewed prior to any changes being implemented.

The ability for dependencies module 460 to accurately recognize discrepancies between financial application architecture 300 and the SOR is dependent on the ability of the users to maintain the data and the accuracy of the data from the SOR. The data from the SOR typically is not considered reconciled on a daily basis but more than likely on a monthly, quarterly and annual basis. Most systems have the ability to provide reconciled data from their SOR at the time that statements are ready to be run based on this data. This data is available as of Trade Date or Settlement Date for the prior Month end date and is typically available 5-7 days after the month end period. When the statements are run based on the data from the SOR, the SOR should provide us the same data so that financial application architecture 300 can be in synch with the statements released to the clients.

The way in which reconciliation module 460 functions is dependant on the type of information provided by the SOR, or data to be used for comparison with data in data model 351. There is also the dependence on the way in which the portfolio accounting component 337 is used. Decisions made on how to use portfolio accounting component 337 reflects on the data stored in financial data model 351. Consistent data elements exist such that the two systems can be compared in detail.

In order for reconciliation component 334 to operate correctly there are a number of questions and analysis that needs to be done on both the SOR and the reconciliation workflow process currently in place at the Institution. The reconciliation component 334 is adjusted to facilitate the type of reconciliation workflow that the following questions help determine. Keep in mind that every institution has their own unique reconciliation workflow and this component should be able to be customized to accommodate the users current and future reconciliation needs. The following is a list of just some of the questions that are answered prior to implementing this component:
1. Is the data from the SOR trade date or settlement date based?
2. Is the data from the SOR reconciled data?
3. How often is data from the SOR available?
4. Are cash holdings reflected on a cash or accrual basis?
5. When do positions reflect corporate actions posted to accounts on the SOR?
6. Are there multiple SOR systems that the universe of Finaplex accounts needs to be reconciled to? If yes, what are these systems and characteristics?
7. Does the SOR provide tax lot data or position data?
8. Can the SOR provide Quantity, Market Values and Cost Basis values?
9. What is the process to report to the SOR discrepancies that exist in the SOR data?
10. How are ACAT transactions reflected in the SOR data and how are cost basis updates reported?
11. How are failed/cancelled trades reported?
12. How are adjustments/reversals/deletions made in the SOR data?

Reconciliation component 400 also includes a standards compliance module 470. Standards compliance module 470 generates audit trail reports as part of the reconciliation process to help identify those accounts that have been changed since the last reconciliation date. There is an audit trail for all data maintained or adjusted by the any user, either manually or automatically. The date, time and name of the individual as well as the changes from and to are noted. For example, this information could be used by the system to show a list of all accounts whose information has been changed from the last reconciliation date to the current date. If the user, has the whole universe of accounts to be reconciled for the day the user can prioritize the accounts they wish to reconcile by using this list. These could be the first set of accounts that the user reconciles for the day, while the inactive accounts are postponed for reconciliation during the later part of the day. Then, a reconciliation specialist can address the accounts that are more than likely to show a discrepancy than those accounts that have not been altered since the last reconciliation date.

Statement close date, or more commonly known, book closing date should be available to be set within an account so that administrators need to be prompted that they are not to change data/transactions prior to this date. The altering of information prior to this date should cause the administrator to regenerate statements or notify the SOR administrator (or manager of the account(s), this should be institution admininstrator defined) of the error so that a correction can be made and sent to the clients for disclosure.

Standards compliance module 470 includes data control mechanisms. Account data and data used for the dependant components are distinguished between reconciled and unreconciled groups. The institution decides how to display either type of data to all users or to selected users. Some institutions may limit the data seen by customers versus reconciliation specialists or institutional users. The compliance module 470 discerns which data is reconciled versus unreconciled for a specified date range. The ability to control data that is released for each user to view is controlled by the institutional administrator, which is set at either the institutional level or account level.

As reconciliation specialists are reconciling or modifying data, the customer should not be viewing the changes for discrepancies as they are occurring but instead see them once the specialist has completed all changes. During the time a reconciliation specialist is adjusting the data for reconciliation, information on reports are designated as unreconciled as per the institution's business requirements. The institution may request a standard disclaimer or even a specific marking on the information with a corresponding footnote. Once a reconciliation specialist completes all changes he/she will need to review his/her adjustments to make sure the adjustment has the desired effect. Upon confirmation or reconciliation of the account or other data, this data is released to the customer, if it has not yet been released. The format of the data is decided upon by the Institution as to how they would like for the reconciled vs. unreconciled data to appear to their customers. Users will see indications as to whether data is reconciled or unreconciled and the date of the last reconciliation, either directly on the displayed page or as a characteristic of the account or data element.

Reconciliation specialists indicate if an account, position of an account, and tax lot of an account is to be considered part of the holdings reconciliation reporting. This is done by the user creating a transaction in the account using the transaction component (not shown in business components 331). When a reconciled transaction code is used the user will be prompted to populate the following transaction fields: Transaction Code, Account Number, Security Type, Security Symbol, and Security.

The main user group for the reconciliation component 400 are the reconciliation specialists, these are typically institutional users but could potentially be users as designated by the institution who are a third party reconciliation service. The SOR data that is being compared to will typically only be used by these reconciliation specialists while the data within financial application architecture 300 that is being reconciled will be able to be made available to all user types. The reconciliation specialists can also be separated into sub-groups of users who may work on specified areas of reconciliation. For instance there are some institutions that will have users who only work on income processing reconciliation while others are focused on maintaining trade activity reconciliation. The following are examples of areas of reconciliation users can be entitled to:
Security Information (pricing, foreign exchange rates, security classifications, interest/dividend rates, etc.);
Corporate Action Transactions (fixed income, mutual finds, equities, etc.);
Trading Transactions (fixed income, mutual funds, equities, etc.);
Cash Disbursements/Receipts Transactions;
ACH Transactions;
Account Information (characteristics of the account—Name/Address/etc.);
Reporting (alerts, generation,etc.);
Data Control (defining users/data availability); and
Adjustment of transactions.

Upon the initial use of reconciliation component 334, users should designate which data from financial application architecture 300 will be used to compare against what sets of data received from other systems. For instance, if an account needs to be reconciled against data received from the Schwab Brokerage System and another account needs to be reconciled against data received from the Pershing Brokerage System, the user should be able to indicate this at the account, position and even security level. There is the potential for multiple data sets to be received for a client's accounts where some accounts should be reconciled against one system and other accounts against another system. This data matching criteria is mapped within the boundary interface 336.

Once the data matching criteria has been determined, the user can choose which data elements will be compared for reconciliation, quantity, market value and/or cost. There is a set of data matching criteria like account and security identifier that are the same in the two or more systems being matched so that the other data elements for the holdings can be compared.

The cash accounting method is defined in the portfolio accounting component 337, the holdings reconciliation component 334 has the ability to compare cash positions based on Trade Date or Settlement and to include or exclude accruals. Accrual accounting refers to the treatments of income and expense type of transactions. Cash reconciliation allows for Trade or Settlement date accounting of cash holdings. Cash reconciliation also allows the option for users to include accrual cash holdings. Most systems can only provide Trade or Settlement date holdings that do not include accrual cash holdings.

Reconciliation component 334 includes a utility that generates a reconciliation worksheet. The reconciliation worksheet utility allows users to view by account(s) the discrepancies with holdings detail and transaction detail in one screen. The user has the ability to view either a single account for all holdings that are unreconcilied or view all accounts with a discrepancy for a single security. There are two main sections that are presented to the user, the holdings details and transaction details. A third section lists various reports to aid in researching the discrepancies.

Reconciliation component 334 includes utilities that generate reports to help users. These reports include information such as: holdings/transactions in related account(s), corporate actions activity for securities within this account, transaction reporting, holdings reporting, security information detail lookup, boundary interface error reports, account information details, audit trails of data changes affecting the account/security/corporate actions, and a link to the SOR.

Missing information reports are available to identify the missing data elements. These reports are used to identify where calculation errors could occur in the reporting 338, portfolio accounting 337, alerts 339, and performance 391 components. Users run these reports as of any date or From/To any dates at any point in time.

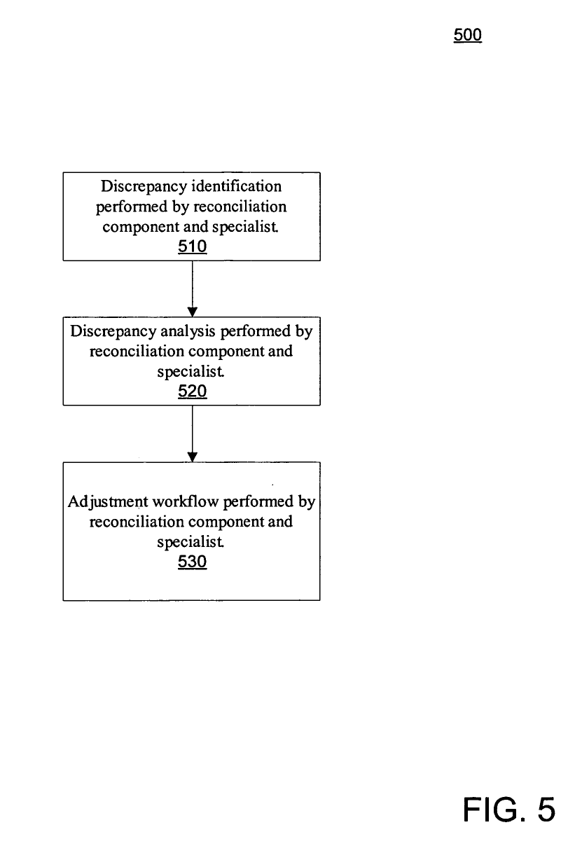

FIG. 5 illustrates a flow diagram of an exemplary reconciliation process 500, according to one embodiment of the present invention. There are a number of steps involved in the reconciliation process. Primarily there are three major functions to the reconciliation process, identification 510, analysis 520 and adjustment 530. Described below are these functions performed at each reconciliation cycle for holdings reconciliation.

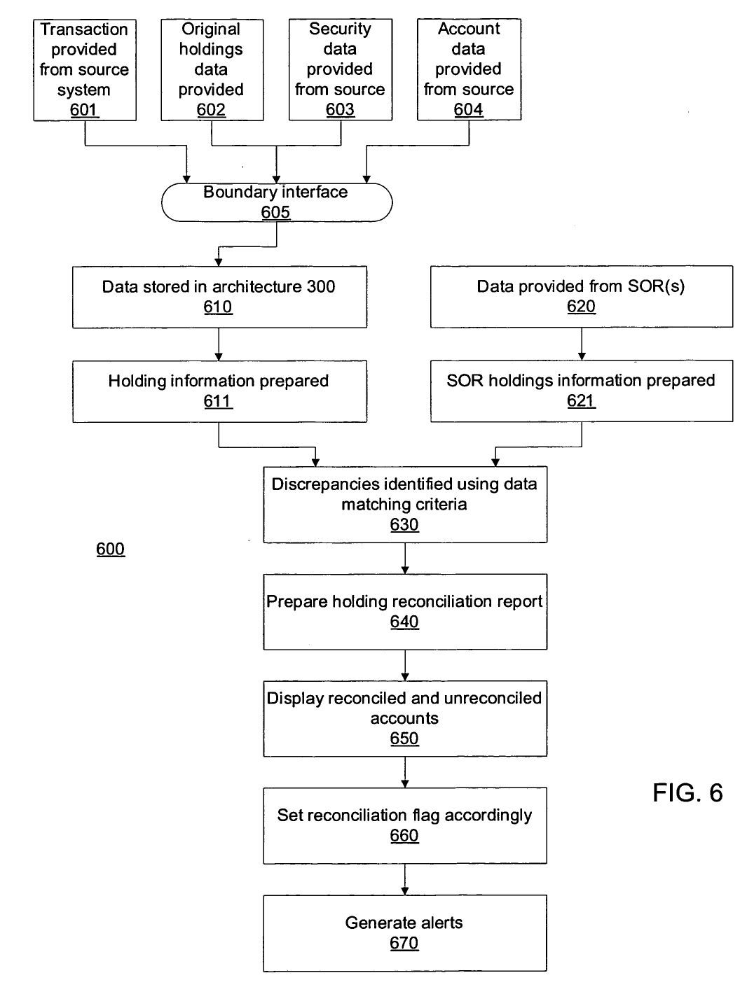

Identification 510. A reconciliation specialist is notified of all accounts that have a discrepancy with the SOR. FIG. 6 illustrates a flow diagram of an exemplary discrepancy identification process 600, according to one embodiment of the present invention. Data is collected from source systems (SORs), such as transaction details (601), original holdings data (602), security data (603), and account data (604). This data is passed to the boundary interface 336 (605). The collected data is stored in financial application architecture 300. (610) The holdings information is updated in financial application architecture 300. (611) The SOR independently provides data to in financial application architecture 300. (620) The SOR holdings information is updated in financial application architecture 300. The holdings information from the source system is compared to the data provided by the SOR using the data matching criteria. (630) At the initial system configuration period, the user designates which accounts reconcile to which data (if multiple data sources are used). [June—what is the difference between the source system (is this simply stock quote updates?) and the SOR (the actual data from the brokerage?)?]

A holdings reconciliation report is generated as described above. (640) The reconciliation component 334 compares the data elements from the SOR chosen by the user to the data stored in data model 351 for each account or portfolio. The user designates which elements to reconcile, trade date basis (or settlement date basis), currency, as of future date, accounts to reconcile, and tolerance settings, according to one embodiment.

Reconciliation reports are available on the system, and also can be automatically sent to a reconciliation specialist's e-mail account, or even automatically printed on a printer. The report output displays the accounts which are either reconciled or unreconciled and the details of each discrepancy for the unreconciled account(s). (650) Reconciled and unreconciled account groups are created if a user has chosen it as an output option. A reconciliation flag is set to “Yes” and the reconciliation date is set to the “As of date” value set in the report for each account listed in the report. (660) Alerts are generated based on the results of the report. Users are notified of accounts which have discrepancies (or for specific types of discrepancies).

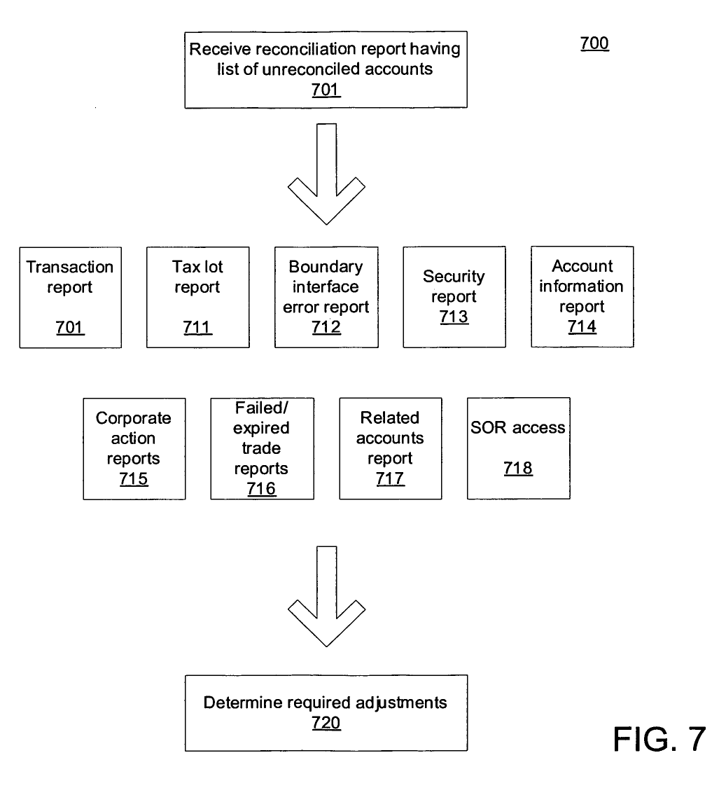

Analysis Workflow 520. Once the reconciliation specialist is aware of those accounts that are out of synch with the SOR he/she determines the cause for the discrepancy. If it is determined the SOR is the cause of the discrepancy then the SOR is notified of the error and the account is marked as ‘pending fix’. FIG. 7 illustrates a flow diagram for an analysis process 700, according to one embodiment of the present invention. The reconciliation specialist receives the reconciliation report listing the unreconciled account(s) with tax lot and transaction data. (701) From the report (or alerts) the reconciliation specialist can analyze transaction reports (710), tax lot reports (711), boundary interface error reports (712), security (audit) reports (713), account information (714), corporate action reports (715), failed/expired trade reports (716), and reports to view related accounts (717). The transaction reports (710) show activity posted to the account after the last reconciliation date. The tax lot reporting (711) includes information for the current date and last reconciliation date. The boundary interface error report (712) includes missing transactions for default mappings. The security reports (713) provides audit trails that can be used for market value discrepancies. The account information report (714) tracks changes to the account that can affect calculations. The corporate action report (715) shows activity posted since the last reconciliation date. The failed/expired reports (716) show trade date reconciliation information from the trade order entry system. The related accounts report (717) show related accounts for a common household. Additionally, the reconciliation specialist can have access to the system of record to compare data relating to transactions, security, holdings, corporate actions, and trading. (718)

The reconciliation specialist determines the necessary adjustment, whether the information in data model 351 needs to be adjusted for discrepancies originating from the source data or if the SOR needs to be adjusted for discrepancies originating from the SOR. If the discrepancy is in the SOR, a message is provided that indicates that the fix is pending until a specific date that the SOR is updated. At that date the account will be reconciled again to confirm the SOR was accurately updated.

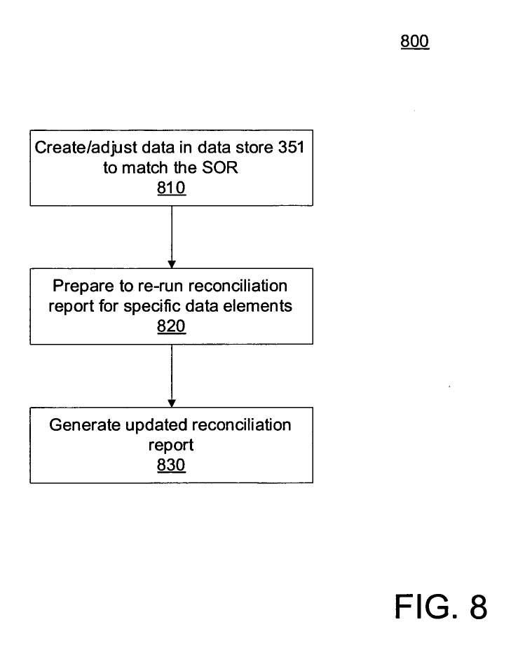

Adjustment Workflow 530. After analysis of all the information that can cause a discrepancy in the data, the reconciliation specialist determines the next course of action. FIG. 8 illustrates a flow diagram of an exemplary adjustment workflow 800, according to one embodiment of the present invention. Assuming the discrepancy is caused by an issue in the data model 351, workflow 800 describes the process the reconciliation specialist uses to resolve the discrepancy. The reconciliation specialist creates or adjusts the data in data model 351 to match the data from the SOR. (810) The holdings reconciliation report is rerun. (820) This confirms that all accounts previously found to be unreconciled are now reconciled. A reconciliation report is generated. (830) If there are still unreconciled accounts, processes 700 and 800 are repeated.

A method and system for account reconciliation in a wealth management system has been described with respect to specific examples and subsystems, it will be apparent to those of ordinary skill in the art that it is not limited to these specific examples or subsystems but extends to other embodiments as well.

1. A computer-implemented method, comprising:
creating a financial portfolio account having a plurality of data elements;
receiving financial data from a plurality of systems of record, each system of record of the plurality of systems of record corresponding to one or more data elements of the plurality of data elements; and
reconciling the financial portfolio account with the financial data.

2. The computer-implemented method of claim 1, wherein reconciling the financial portfolio account comprises generating reconciliation reports identifying discrepancies between the financial portfolio account and the financial data.

3. The computer-implemented method of claim 2, wherein a user configures data matching criteria for generating the reconciliation reports.

4. The computer-implemented method of claim 3, wherein reconciling the financial portfolio account further comprises adjusting the financial portfolio account to match the financial data using the reconciliation reports.

5. The computer-implemented method of claim 4, wherein the reconciliation reports include transaction reports, tax lot reports, boundary interface error reports, audit security reports, account information reports, corporate action reports, failed/expired trade reports, and related account reports.

6. The computer-implemented method of claim 5, wherein the discrepancies are identified according to a tolerance setting selected by the user.

7. The computer-implemented method of claim 6, further comprising generating alerts that are delivered to the user when discrepancies are identified.

8. The computer-implemented method of claim 7, wherein different types of adjustments to the portfolio account are permissible by different users having appropriate entitlements.

9. A system, comprising:
means for creating a financial portfolio account having a plurality of data elements;
means for receiving financial data from a plurality of systems of record, each system of record of the plurality of systems of record corresponding to one or more data elements of the plurality of data elements; and
means for reconciling the financial portfolio account with the financial data.

10. The system of claim 9, wherein reconciling the financial portfolio account comprises means for generating reconciliation reports identifying discrepancies between the financial portfolio account and the financial data.

11. The system of claim 10, wherein a user configures data matching criteria for generating the reconciliation reports.

12. The system of claim 11, wherein the means for reconciling the financial portfolio account further comprises means for adjusting the financial portfolio account to match the financial data using the reconciliation reports.

13. The system of claim 12, wherein the reconciliation reports include transaction reports, tax lot reports, boundary interface error reports, audit security reports, account information reports, corporate action reports, failed/expired trade reports, and related account reports.

14. The system of claim 13, wherein the discrepancies are identified according to a tolerance setting selected by the user.

15. The system of claim 14, further means for comprising generating alerts that are delivered to the user when discrepancies are identified.

16. The system of claim 15, wherein different types of adjustments to the portfolio account are permissible by different users having appropriate entitlements.

17. A computer-readable medium having stored thereon a plurality of instructions, said plurality of instructions when executed by a computer, cause said computer to perform:
creating a financial portfolio account having a plurality of data elements;
receiving financial data from a plurality of systems of record, each system of record of the plurality of systems of record corresponding to one or more data elements of the plurality of data elements; and
reconciling the financial portfolio account with the financial data.

18. The computer-readable medium of claim 17, having stored thereon additional instructions, said additional instructions when executed by a computer for reconciling the financial portfolio account, cause said computer to further perform generating reconciliation reports identifying discrepancies between the financial portfolio account and the financial data.

19. The computer-implemented method of claim 18, wherein a user configures data matching criteria for generating the reconciliation reports.

20. The computer-readable medium of claim 19, having stored thereon additional instructions, said additional instructions when executed by a computer for reconciling the financial-portfolio account, cause said computer to further perform adjusting the financial portfolio account to match the financial data using the reconciliation reports.

21. The computer-readable medium of claim 20, wherein the reconciliation reports include transaction reports, tax lot reports, boundary interface error reports, audit security reports, account information reports, corporate action reports, failed/expired trade reports, and related account reports.

22. The computer-readable medium of claim 21, wherein the discrepancies are identified according to a tolerance setting selected by the user.

23. The computer-readable medium of claim 22, having stored thereon additional instructions, said additional instructions when executed by a computer, cause said computer to further perform generating alerts that are delivered to the user when discrepancies are identified.

24. The computer-readable medium of claim 23, wherein different types of adjustments to the portfolio account are permissible by different users having appropriate entitlements.
